(19) United States
(12) Patent Application Publication
(10) Pub. No.: US 2026/0135435 A1
(43) Pub. Date: May 14, 2026

(54) ELECTRIC APPARATUS

(71) Applicant: TOYOTA JIDOSHA KABUSHIKI KAISHA, Toyota-shi (JP)

(72) Inventors: Masahiro TANAKA, Nagoya-shi (JP); Kazuaki ISHIURA, Okazaki-shi (JP); Masataka IWAMOTO, Toyota-shi (JP); Kenshi YAMANAKA, Aichi-ken (JP)

(73) Assignee: TOYOTA JIDOSHA KABUSHIKI KAISHA, Toyota-shi (JP)

(21) Appl. No.: 19/350,145

(22) Filed: Oct. 6, 2025

(30) Foreign Application Priority Data
Nov. 8, 2024 (JP) 2024-195844

(51) Int. Cl. H02K 5/22; H02K 11/33

(52) U.S. Cl. CPC H02K 5/225; H02K 11/33

(57) ABSTRACT

An electric apparatus may include: a first housing having an opening; a second housing configured to close the opening; a first terminal provided in the first housing and extending along an approaching direction in which the second housing approaches the first housing to connect to the first housing; a first connector provided in the second housing and connected to the first terminal; a second terminal provided in one of the first housing and the second housing and extending parallel to the first terminal; and a second connector provided in other of the first housing and the second housing and connected to the second terminal. A first stroke which is an inserted length of the first terminal in the first connector may be longer than a second stroke which is an inserted length of the second terminal in the second connector.

### REFERENCE TO RELATED APPLICATION

This application claims priority to Japanese Patent Application No. 2024-195844 filed on November 8, 2024. The entire content of the priority application is incorporated herein by reference.

### TECHNICAL FIELD

The art herein relates to an electric apparatus.

### BACKGROUND

Japanese Patent Application Publication Nos. 2016-139539 and 2016-139540 each describe an electric apparatus in which a motor and an inverter are housed in a single housing. The housing is divided to a first housing and a second housing, the motor is housed in the first housing, and the inverter is housed in the second housing. A terminal is located in the first housing, and a connector is located in the second housing. The terminal and the connector fit together when the second housing connects to the first housing.

In case a plurality of terminals is located in the first housing and the terminals contact their corresponding connectors simultaneously, a resistance force sharply changes during the connection of the second housing to the first housing. The disclosure herein provides a structure that mitigates a sharp change in a resistance force during connection of a second housing to a first housing.

### SUMMARY

An electric apparatus disclosed herein may comprise a first housing having an opening; a second housing configured to connect to the first housing and close the opening; a first terminal provided in the first housing, wherein the first terminal extends along an approaching direction in which the second housing approaches the first housing to connect to the first housing; a first connector provided in the second housing and connected to the first terminal; a second terminal provided in one of the first housing and the second housing, wherein the second terminal extends parallel to the first terminal; and a second connector provided in other of the first housing and the second housing, wherein the second connector is connected to the second terminal. A first stroke which is an inserted length of the first terminal in the first connector may be longer than a second stroke which is an inserted length of the second terminal in the second connector.

As the second housing approaches the first housing, the first terminal with the longer stroke contacts its corresponding connector (i.e., the first connector) before the second terminal contacts its corresponding connector. Then, after the first terminal has contacted the connector, the second terminal contacts its corresponding connector (i.e., the second connector). This sequential contact of the first and second terminals with their corresponding connectors mitigates a change in a resistance force during the connection of the second housing to the first housing.

Details of the art disclosed herein and further developments will be described in DETAILED DESCRIPTION.

### BRIEF DESCRIPTION OF DRAWINGS

FIG. 1 is a cross-sectional view of an electric apparatus (a motor unit) according to an embodiment.

FIG. 2 is a cross-sectional view of the electric apparatus (the motor unit) according to the embodiment (where a second housing is separated from a first housing).

FIG. 3 is a cross-sectional view of the electric apparatus (the motor unit) according to the embodiment (where knock pins are in contact with knock holes).

FIG. 4 is a cross-sectional view of the electric apparatus (the motor unit) according to the embodiment (where first terminals are in contact with a first connector).

FIG. 5 is a cross-sectional view of the electric apparatus (the motor unit) according to the embodiment (where second terminals are in contact with a second connector).

FIG. 6 is a cross-sectional view of the electric apparatus (the motor unit) according to the embodiment (where a second terminal block is separated from an electric motor).

### DETAILED DESCRIPTION

Referring to the drawings, an electric apparatus according to an embodiment is described. The electric apparatus according to the embodiment is a motor unit 10 in which an electric motor and an inverter are housed in a single housing.

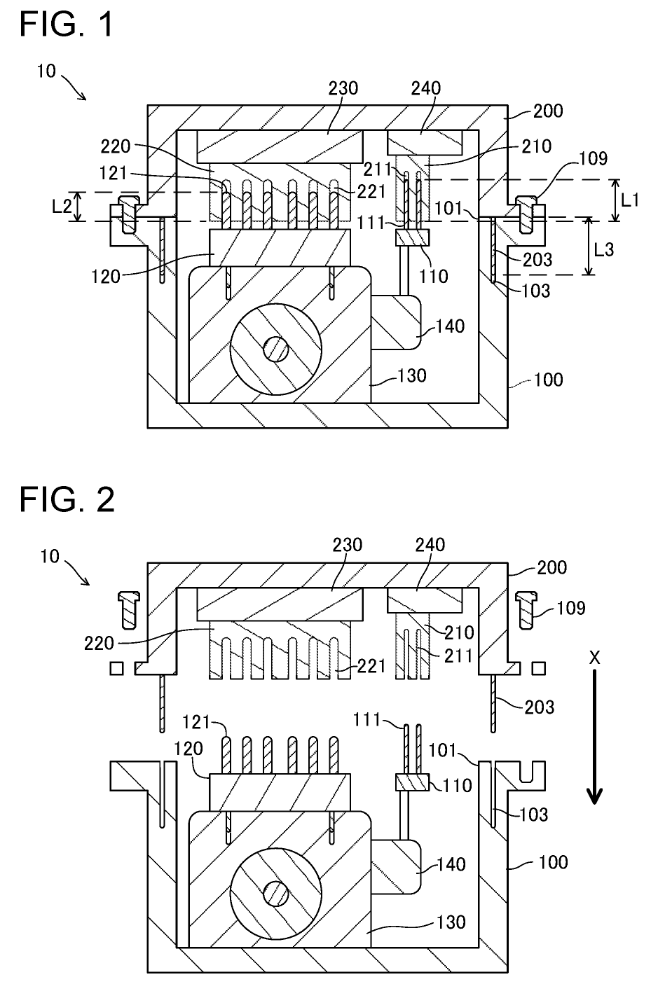

FIG. 1 depicts a cross section of the motor unit 10. In the motor unit 10, an electric motor 130, an inverter 230, and a controller 240 are housed in a single housing. Hereinafter, the electric motor 130 is simply referred to as the motor 130. In the drawings, configurations of the motor 130, the inverter 230, and the controller 240 are not depicted in detail.

The single housing is divided into a first housing 100 and a second housing 200. The first housing 100 has an opening 101, and the second housing 200 is configured to connect to the first housing 100 and close the opening 101. The second housing 200 is fixed to the first housing 100 with bolts 109.

The motor 130 is housed in the first housing 100. A gear set (not depicted) is also housed in the first housing 100. The motor unit 10 is a power unit mounted in an electric vehicle. The primary shaft of the motor 130 is engaged with an input gear of the gear set, and an output gear of the gear set is engaged with an axle. In the drawings, some components related to the electric vehicle are not depicted.

The inverter 230 and the controller 240 are housed in the second housing 200. The controller 240 determines a target output of the motor 130 using information from a sensor (described later) and controls the inverter 230 based on the target output. The inverter 230 generates AC electricity to drive the motor 130 based on commands from the controller 240.

A sensor 140 is provided at the motor 130. The sensor 140 is, for example, a resolver configured to detect a rotation angle of the rotor of the motor 130 or an oil temperature sensor configured to measure a temperature of oil in the motor 130. The sensor 140 is electrically connected to the controller 240 via a plurality of first terminals 111 and a first connector 210. The first connector 210 comprises a plurality of first sockets 211, and the number of the first sockets 211 is the same as the number of first terminals 111. The plurality of first terminals 111 is inserted in the first connector 210 and each of the first terminals 111 is in contact with corresponding one of the first sockets 211, so that the sensor 140 is electrically connected to the controller 240. A sensor signal is transmitted from the sensor 140 to the controller 240 via the first terminals 111 and the first connector 210. Electricity indicative of sensor data flows through the first connector 210 and the plurality of first terminals 111.

The inverter 230 and the motor 130 are electrically connected to each other via a plurality of second terminals 121 and a second connector 220. The second connector 220 comprises a plurality of second sockets 221, and the number of the second sockets 221 is the same as the number of the second terminals 121. The second terminals 121 are inserted in the second connector 220 and each of the second terminals 121 is in contact with corresponding one of the second sockets 221, so that the motor 130 and the inverter 230 are electrically connected to each other. The inverter 230 generates AC electricity to drive the motor 130, and the AC electricity is supplied to the motor 130 through the plurality of second terminals 121 and the second connector 220. A large amount of electricity flows through the plurality of second terminals 121 and the second connector 220 to drive the motor 130.

The electricity flowing through the first terminals 111 and the first connector 210 is smaller than the electricity flowing through the second terminals 121 and the second connector 220.

The plurality of first terminals 111 is located on a first terminal block 110, and the first terminal block 110 is fixed to an inner wall of the first housing 100. In the drawings, the point of fixation between the first terminal block 110 and the first housing 100 is not shown. The plurality of second terminals 121 is located on a second terminal block 120, and the second terminal block 120 is fixed to the motor 130. That is, the first terminals 111 and the second terminals 121 are fixed to the first housing 100. In other words, the first terminals 111 and the second terminals 121 are provided in the first housing 100.

The first connector 210 is fixed to the controller 240, and the second connector 220 is fixed to the inverter 230. That is, the first connector 210 and the second connector 220 are fixed to the second housing 200. In other words, the first connector 210 and the second connector 220 are provided in the second housing 200.

FIG. 2 depicts a cross section of the motor unit 10, where the second housing 200 is separated from the first housing 100. In the state where the second housing 200 is separated from the first housing 100, the first terminals 111 are separated from the first connector 210 and the second terminals 121 are separated from the second connector 220. In a manufacturing process of the motor unit 10, the second housing 200 is brought closer to the first housing 100 in a direction of bold arrow X in FIG. 2 to connect to the first housing 100. The first terminals 111 and the second terminals 121 extend in the direction of bold arrow X in FIG. 2. In other words, the first terminals 111 and the second terminals 121 extend in an approaching direction of the second housing 200 toward the first housing 100 for connection of the second housing 200 to the first housing 100. Thus, in the course of connection of the second housing 200 to the first housing 100, the first terminals 111 connect to the first connector 210 and the second terminals 121 connect to the second connector 220. Here, a first stroke L1 which is an inserted length of the first terminals 111 in the first connector 210 is longer than a second stroke L2 which is an inserted length of the second terminals 121 in the second connector 220 (the first stroke L1 and the second stroke L2 are indicated in FIG. 1). This ensures that the first terminals 111 contact the first connector 210 before the second terminals 121 contact the second connector 220 as the second housing 200 approaches the first housing 100.

The second housing 200 comprises knock pins 203 for alignment with the first housing 100, and the first housing 100 comprises knock holes 103 configured to receive the knock pins 203. The knock pins 203 extends in the direction of bold arrow X in FIG. 2. In other words, the knock pins 203 extend in the approaching direction of the second housing 200 toward the first housing 100 for connection to the first housing 100. The knock pins 203, the first terminals 111, and the second terminals 121 extend parallel to each other.

A third stroke L3 which is an inserted length of the knock pins 203 in the knock holes 103 is longer than the first stroke L1, which is the inserted length of the first terminals 111 in the first connector 210 (the third stroke L3 is indicated in FIG. 1). This means that the knock pins 203 contact the knock holes 103 before the first terminals 111 contact the first connector 210 as the second housing 200 approaches the first housing 100. That is, in the course of connection of the second housing 200 to the first housing 100, the knock pins 203 first contact the knock holes 103, then the first terminals 111 contact the first connector 210, and finally the second terminals 121 contact the second connector 220. This sequential order of contact is ensured by the relationship of L3>L1>L2.

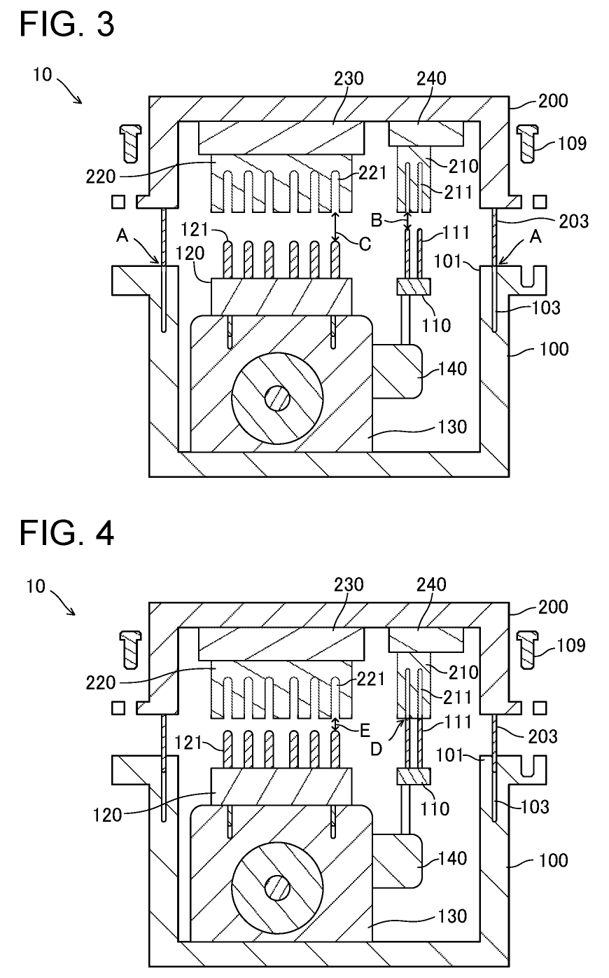

FIG. 3 depicts the state where the knock pins 203 have just contacted the knock holes 103 as the second housing 200 approaches the first housing 100. The points of contact between the knock pins 203 and the knock holes 103 are indicated with arrows A. In this state, the first terminals 111 are separated from the first connector 210 by a distance B, and the second terminals 121 are separated from the second connector 220 by a distance C.

As the second housing 200 further approaches the first housing 100, the leading ends of the knock pins 203 are inserted into the knock holes 103, thereby aligning the second housing 200 with the first housing 100. Thereafter, the first terminals 111 contact the first connector 210.

FIG. 4 depicts the state where the leading ends of the first terminals 111 have just contacted the first connector 210. The point of contact between the first terminals 111 and the first connector 210 is indicated with an arrow D. In this state, the second terminals 121 are separated from the second connector 220 by a distance E.

As the second housing 200 further approaches the first housing 100, the leading ends of the first terminals 111 are inserted into the first connector 210, and at the same time, the leading ends of the second terminals 121 contact the second connector 220.

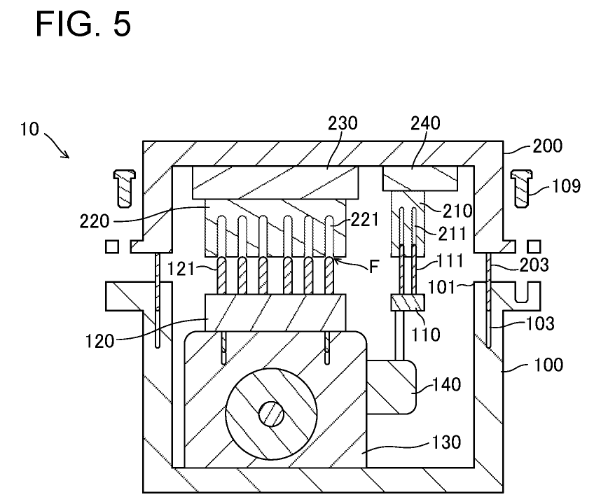

FIG. 5 depicts the state where the leading ends of the second terminals 121 have just contacted the second connector 220. The point of connection between the second terminals 121 and the second connector 220 is indicated with an arrow F. In this state, the leading end portions of the first terminals 111 are already inserted in the first connector 210.

As the second housing 200 further approaches the first housing 100, a flange of the second housing 200 contacts a flange of the first housing 100. FIG. 1 depicts the state where the second housing 200 is completely connected to the first housing 100.

As described above, in the course of the second housing 200 approaching the first housing 100, the knock pins 203 first contact the knock holes 103, then the first terminals 111 contact the first connector 210, and finally the second terminals 121 contact the second connector 220. This sequential order of contact is ensured by the relationship of L3>L1>L2. Advantages of the sequential contact of the knock pins 203, the first terminals 111, and the second terminals 121 are described below.

The leading ends of the knock pins 203 are inserted into the knock holes 103 before the first terminals 111 and the second terminals 121 contact the connectors. That is, the second housing 200 is aligned with the first housing 100 before the first terminals 111 and the second terminals 121 contact the connectors. This allows for secure insertion of the first terminals 111 into the first connector 210 and secure insertion of the second terminals 121 into the second connector 220.

Once the first terminals 111 and the second terminals 121 sequentially start to contact the connectors, a resistance force gradually increases as the second housing 200 approaches the first housing 100. If the first stroke L1 were equal to the second stroke L2, the first terminals 111 and the second terminals 121 would simultaneously contact their corresponding connectors. This may lead to a sharp change in the resistance force in the second housing 200 approaching the first housing 100. The difference between the first stroke L1 and the second stroke L2 mitigates such a sharp change in the resistance force.

Electricity flowing through the first terminals 111 is smaller than electricity flowing through the second terminals 121, and thus the first terminals 111 may be thinner and weaker than the second terminals 121. A resistance force in inserting the first terminals 111 into the first connector 210 is lower than a resistance force in inserting the second terminals 121 into the second connector 220. This feature is also advantageous. The insertion of the first terminals 111 into the first connector 210 starts before the insertion of the second terminals 121 into the second connector 220. In this case, even a slight change in the resistance force occurring while the second housing 200 is approaching the first housing 100 may be attributed to improper insertion of the first terminals 111. If the second terminals 121 with a larger resistance force upon insertion contacted the second connector 220 before the first terminals 111 contact the first connector 210, a slight change in the resistance force between the first terminals 111 and the first connector 210 could not be detected since the resistance force of the second terminals 121 is large. Thus, contacting the terminals with a smaller resistance force with the connector first improves detection sensitivity for improper insertion.

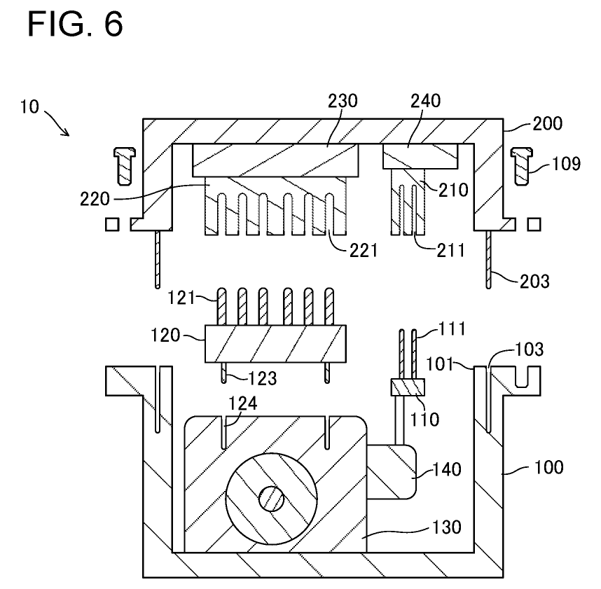

In FIG. 6, the second terminal block 120 is depicted as being separated from the motor 130. The second terminal block 120 comprises knock pins 123, and the motor 130 comprises knock holes 124. The knock pins 123 and the knock holes 124 align the second terminal block 120 with the motor 130. The knock pins 123 and the knock pins 203 extend parallel to each other. The knock pins 203 and the knock pins 123 may have the same size, and the knock holes 103 and the knock holes 124 may have the same size. This improves efficiency for forming of the knock pins and the knock holes. Knock pins (and knock holes) for aligning the first terminal block 110 with the first housing 100 may have the same size as the size of the knock pins 203 (and the knock holes 103), although this is not depicted.

Some of points to be noted regarding the art described in the embodiment will be listed. The bold arrow X in FIG. 2 indicates the “approaching direction of the second housing 200 toward the first housing 100 for connection to the first housing 100”. The knock pins 203 for alignment of the second housing 200 with the first housing 100 extend along the bold arrow X. That is, the “approaching direction of the second housing 200 toward the first housing 100 for connection to the first housing 100” may be expressed in other words as “an extending direction of the knock pins 203 for alignment of the second housing 200 with the first housing 100”.

The first stroke L1 refers to the length of portions of the first terminals 111 that are inserted in the first connector 210 out of the overall length of the first terminals 111. The second stroke L2 refers to the length of portions of the second terminals 121 that are inserted in the second connector 220 out of the overall length of the second terminals 121. The third stroke L3 refers to the length of portions of the knock pins 203 that are inserted in the knock holes 103 out of the overall length of the knock pins 203.

In the motor unit 10, one of the first housing 100 and the second housing 200 may comprise the knock pins 203 for alignment, and the other thereof may comprise the knock holes 103 into which the knock pins 203 are inserted. The stroke of the knock pins 203 (i.e., the third stroke L3) may be longer than the first stroke L1.

The “resistance force in inserting the first terminals 111 into the first connector 210” refers to a force generated between the first terminals 111 and the first connector 210 in inserting the first terminals 111 into the first connector 210, wherein this force is generated in the opposite direction to the insertion direction. In other words, the “resistance force in inserting the first terminals 111 into the first connector 210” is a frictional force generated between the first terminals 111 and the first connector 210 in inserting the first terminals 111 into the first connector 210. The same applies to the “resistance force in inserting the second terminals 121 into the second connector 220”.

The terms “first housing 100” and “second housing 200” are used for convenience purposes to distinguish two housings divided from the single housing. The first housing 100 (the second housing 200) is interchangeable with the second housing 200 (the first housing 100). Similarly, the term “first terminals 111” is interchangeable with the term “second terminals 121”, and the term “first connector 210” is interchangeable with the term “second connector 220”.

In the motor unit 10, the first terminals 111 may be connected to the first connector 210 and the second terminals 121 may be connected to the second connector 220 through the opening 101 of the first housing 100. The knock pins 203 for alignment of the second housing 200 with the first housing 100 extend perpendicular to a surface (opening surface) of the opening 101.

In the motor unit 10 according to the embodiment, the first terminals 111 and the second terminals 121 are fixed to the first housing 100, and the first connector 210 and the second connector 220 are fixed to the second housing 200. Instead of this, the first terminals 111 and the second connector 220 may be fixed to the first housing 100, and the second terminals 121 and the first connector 210 may be fixed to the second housing 200. That is, the second terminals 121 may be fixed to one of the first housing 100 and the second housing 200, and the second connector 220 may be fixed to the other of the first housing 100 and the second housing 200. In other words, the second terminals 121 may be provided in one of the first housing 100 and the second housing 200, and the second connector 220 may be provided in the other of the first housing 100 and the second housing 200.

The electric apparatus according to the embodiment is the motor unit 10 comprising the motor 130, the inverter 230, and the controller 240. The housing of the motor unit 10 is divided into the first housing 100 and the second housing 200. The electric motor 130 is housed in the first housing 100, and the inverter 230 configured to drive the electric motor 130 and the controller 240 configured to control the inverter 230 are housed in the second housing 200. Instead of this, the electric motor 130 may be housed in the second housing 200, and the inverter 230 and the controller 240 may be housed in the first housing 100. That is, the electric motor 130 may be housed in one of the first housing 100 and the second housing 200, and the inverter 230 and the controller 240 may be housed in the other thereof. The first terminals 111 and the first connector 210 connect the sensor 140 associated with the electric motor 130 to the controller 240. The second terminals 121 and the second connector 220 connect the electric motor 130 to the inverter 230.

The technology disclosed herein is not limited to the motor unit 10. The technology disclosed herein is applicable to any structures comprising electric devices and a dividable housing that houses the electric devices. The first housing may be referred to as “a housing body having an opening”, and the second housing may be referred to as “a housing cover for closing the opening”. The first terminals and the first connector as well as the second terminals and the second connector electrically connect electric device(s) in the first housing to electric device(s) in the second housing.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. An electric apparatus comprising:
a first housing having an opening;
a second housing configured to connect to the first housing and close the opening;
a first terminal provided in the first housing, wherein the first terminal extends along an approaching direction in which the second housing approaches the first housing to connect to the first housing;
a first connector provided in the second housing and connected to the first terminal;
a second terminal provided in one of the first housing and the second housing, wherein the second terminal extends parallel to the first terminal; and
a second connector provided in other of the first housing and the second housing, wherein the second connector is connected to the second terminal,
wherein a first stroke which is an inserted length of the first terminal in the first connector is longer than a second stroke which is an inserted length of the second terminal in the second connector.

2. The electric apparatus of claim 1, wherein a resistance force in inserting the first terminal into the first connector is lower than a resistance force in inserting the second terminal into the second connector.

3. The electric apparatus of claim 1, wherein
an electric motor is housed in one of the first housing and the second housing,
an inverter for driving the electric motor and a controller for controlling the inverter are housed in other of the first housing and the second housing,
the first terminal and the first connector connect the controller to a sensor related to the electric motor, and
the second terminal and the second connector connect the electric motor to the inverter.

4. The electric apparatus of claim 2, wherein
an electric motor is housed in one of the first housing and the second housing,
an inverter for driving the electric motor and a controller for controlling the inverter are housed in other of the first housing and the second housing,
the first terminal and the first connector connect the controller to a sensor related to the electric motor, and
the second terminal and the second connector connect the electric motor to the inverter.
